(19) United States
(12) Patent Application Publication
(10) Pub. No.: US 2026/0170134 A1
(43) Pub. Date: Jun. 18, 2026

(54) COMPUTING AN EFFICACY OF A CYBERTHREAT DETECTION TECHNIQUE USING PROXIMITY OF DETECTIONS

(71) Applicant: CrowdStrike, Inc., Sunnyvale, CA (US)

(72) Inventors: Vineet Sangar, Bothell, WA (US); Daniel Brown, Ipswich, MA (US)

(21) Appl. No.: 18/982,745

(22) Filed: Dec. 16, 2024

(51) Int. Cl. G06F 21/56

(52) U.S. Cl. CPC G06F 21/566; G06F 2221/034

(57) ABSTRACT

The present disclosure provides techniques for computing an efficacy of a cyberthreat detection technique using proximity of detections. A processing device generates an incident report comprising a plurality of events detected at an endpoint. The processing device performs a scoring process on the plurality of events based on a first cyberthreat detection technique. Responsive to determining, during the scoring process, that a summed score corresponding to at least one event in the plurality of events exceeds a threshold score, the processing device computes a difference between a first timestamp at which the summed score exceeded the threshold score and a second timestamp at which a second cyberthreat detection technique detected a cyberthreat with respect to the endpoint. The processing device outputs an indication of the difference.

### TECHNICAL FIELD

Aspects of the present disclosure relate to cybersecurity, and more particularly, to computing an efficacy of a cyberthreat detection technique using proximity of detections.

### BACKGROUND

Cybersecurity refers to the practice of protecting computer systems, networks, and digital assets from theft, damage, unauthorized access, and various forms of cyber threats. Cybersecurity threats encompass a wide range of activities and actions that pose risks to the confidentiality, integrity, and availability of computer systems and data. These threats can include malicious activities such as viruses, ransomware, and hacking attempts aimed at exploiting vulnerabilities in software or hardware.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example of a system for computing an efficacy of a cyberthreat detection technique using proximity of detections in accordance with some aspects of the present disclosure.

FIG. 2 is a flow diagram of a method of computing an efficacy of a cyberthreat detection technique using proximity of detections in accordance with some aspects of the present disclosure.

FIG. 3 is a flow diagram of a method of computing an efficacy of a cyberthreat detection technique using proximity of detections in accordance with some aspects of the present disclosure.

FIG. 4 is a block diagram that illustrates an example of a system for computing an efficacy of a cyberthreat detection technique using proximity of detections in accordance with some aspects of the present disclosure.

FIG. 5 illustrates a diagrammatic representation of a machine in an example form of a computer system that may perform one or more of the operations described herein in accordance with some aspects of the present disclosure.

### DETAILED DESCRIPTION

Various cyberthreat detection techniques exist to discover cyberthreats (e.g., in-progress cyberattacks) to an endpoint. Performance of various cyberthreat detection techniques may vary. In one example, a first type of cyberthreat detection technique may more accurately detect a first type of cyberthreat compared to a second type of cyberthreat detection technique. Furthermore, some types of cyberthreat detection techniques may tend to focus on evaluating individual events detected at an endpoint, which may be computationally burdensome.

Cyberthreat detection evaluation metrics have been developed to evaluate performance of cyberthreat detection techniques. Some cyberthreat detection evaluation metrics may include receiver operating characteristic (ROC) curves, precision/recall, true positive rate (TPR) curves, and area under the curve (AUC). In an example, an organization may evaluate the effectiveness of cyberthreat detection techniques. If a cyberthreat detection technique performs poorly according to a cyberthreat detection evaluation metric, an organization may modify the cyberthreat detection technique or replace the cyberthreat detection technique with another cyberthreat detection technique in order to improve cybersecurity.

Cyberthreat detection evaluation metrics (e.g., ROC curves, TPR curves, etc.) may tend to focus on how accurately a cyberthreat detection technique detects a cyberthreat. Cyberthreat detection evaluation metrics may tend to ignore latency as an evaluation metric, that is, cyberthreat detection evaluation metrics may ignore a time difference between a time at which cyberthreat detection began and a time at which a cyberthreat was confirmed and surfaced to a computing device (e.g., a security response team device). Furthermore, comparisons of different cyberthreat detection techniques may also ignore latency.

The present disclosure addresses the above-noted and other deficiencies by using a processing device to compute an efficacy of a cyberthreat detection technique using proximity of detections. The present disclosure describes an incident paradigm for cyberthreat detection in which a computing system groups events at an endpoint into an incident report. Once the computing system generates the incident report, the computing system may begin a scoring process in which the computing system scores each event in the events according to a first cyberthreat detection technique. The computing system may sum each score assigned to each event during the scoring process. Once the summed score exceeds a threshold score, the computing system may surface an indication of a cyberattack. The computing system may record a first timestamp (i.e., a date and a time) at which the summed score exceeded the threshold score and a second timestamp at which a second cyberthreat detection technique detected a cyberthreat with respect to the endpoint. The computing system may execute the second cyberthreat detection technique concurrently with the first cyberthreat detection technique or another computing system may execute the second cyberthreat detection and provide the computing system with the second timestamp. The computing system may compute a difference between the first timestamp and the second timestamp and output the difference.

In an example, a processing device generates an incident report comprising a plurality of events detected at an endpoint. The processing device performs a scoring process on the plurality of events based on a first cyberthreat detection technique. Responsive to determining, during the scoring process, that a summed score corresponding to at least one event in the plurality of events exceeds a threshold score, the processing device computes a difference between a first timestamp at which the summed score exceeded the threshold score and a second timestamp at which a second cyberthreat detection technique detected a cyberthreat with respect to the endpoint. The processing device outputs an indication of the difference.

As discussed herein, the present disclosure provides an approach that improves the operation of a computer system by utilizing an incident paradigm to detect a cyberthreat. With more particularity, in comparison to evaluating a large quantity of constantly occurring individual events, the computing system may group events into an incident paradigm and then begin evaluating (e.g., scoring) the events. The computing system may surface an indication of a cyberthreat when a summed score exceeds a threshold score (i.e., when a cyberthreat is detected) once (while continuing the scoring), thereby conserving computing resources associated with surfacing indications of cyberthreats. Thus, vis-à-vis generating an incident report including a plurality of events detected at an endpoint and performing the scoring process, the computing system may conserve computing resources. In addition, the present disclosure provides an improvement to the technological field of cybersecurity by providing for a mechanism to evaluate cyberthreat detection techniques that accounts for latency. For instance, vis-à-vis computing a difference between a first timestamp at which a summed score exceeds a threshold score and a second timestamp at which a second cyberthreat detection technique detected a cyberthreat with respect to the endpoint, the present disclosure may enable an organization to evaluate performance of a cyberthreat detection technique based on latency.

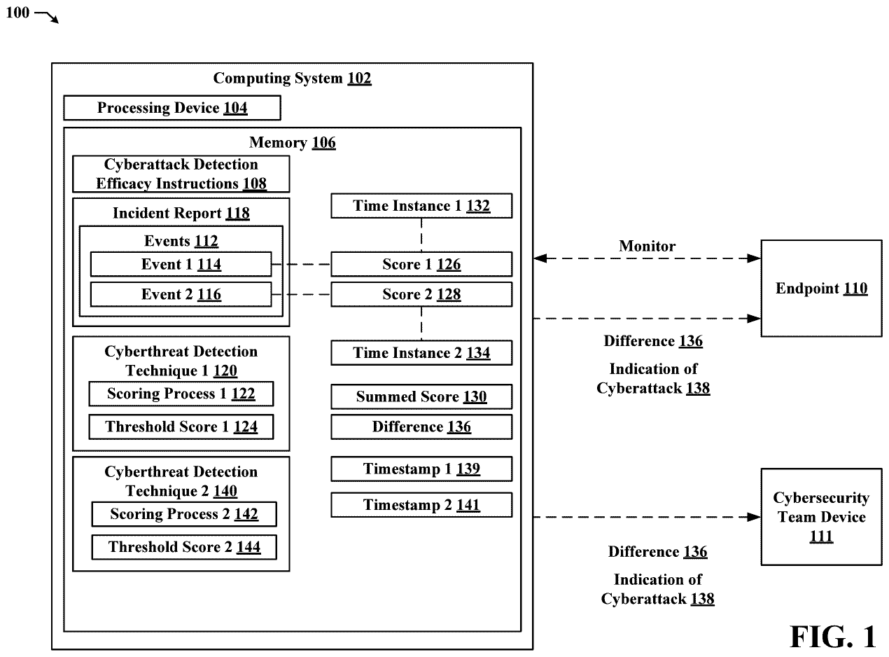

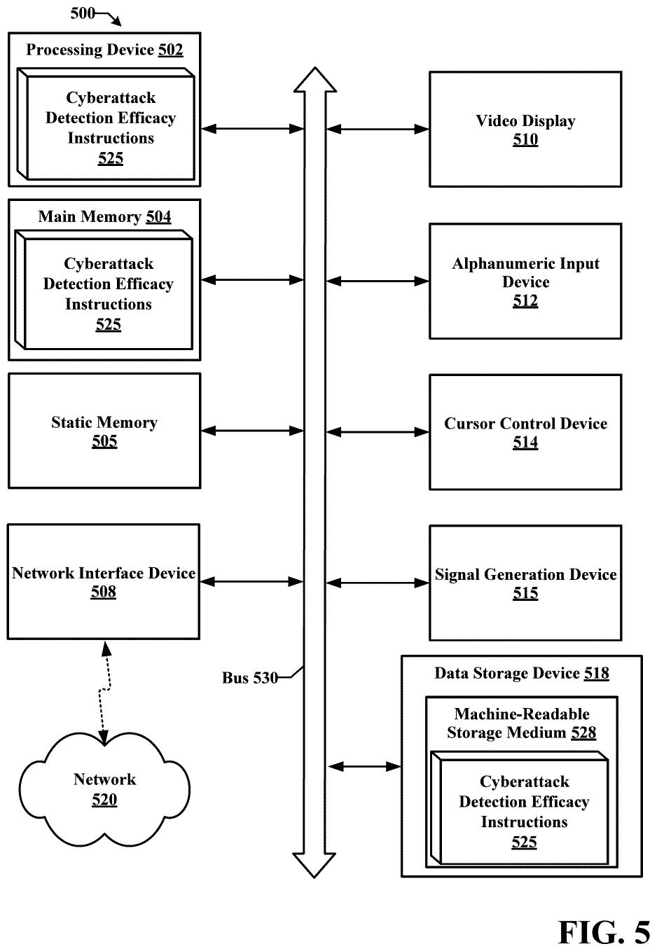

FIG. 1 is a block diagram 100 that illustrates an example of a system for computing an efficacy of a cyberthreat detection technique using proximity of detections in accordance with some aspects of the present disclosure. The system includes a computing system 102. The computing system 102 includes a processing device 104 (e.g., a central processing unit (CPU)) and memory 106. The memory 106 stores cyberattack detection efficacy instructions 108. The cyberattack detection efficacy instructions 108, when executed by the processing device 104, may cause the processing device 104 to perform various aspects described herein pertaining to computing an efficacy of a cyberthreat detection technique using proximity of detections. In an example, the computing system 102 may be or include a desktop computing device, a laptop computing device, a tablet computing device, a server, a cloud server, a smartphone, etc. Although not depicted in FIG. 1, the computing system 102 may include additional components such as input devices, output devices, etc. In some aspects, the computing system 102 may be or include the computer system 500 described in FIG. 5.

The computing system 102 may monitor an endpoint 110 for cybersecurity-related purposes. For example, the computing system 102 may monitor data (e.g., packets) received by the endpoint 110, data (e.g., packets) transmitted by the endpoint 110, processes executed by the endpoint 110, etc. The endpoint 110 may include a processing device and memory (not depicted in FIG. 1). In an example, the endpoint 110 may be or include a desktop computing device, a laptop computing device, a tablet computing device, a server, a cloud server, a smartphone, etc. In some aspects, the computing system 102 and the endpoint 110 communicate with one another and/or other devices via a network (not depicted in FIG. 1), such as the Internet, a local area network (LAN), a wireless local area network (WLAN), etc. Although the computing system 102 is depicted as being separate from the endpoint 110, in some aspects, the computing system 102 may be or include the endpoint 110. In some aspects, the endpoint 110 may be or include the computer system 500 described in FIG. 5. In some aspects, the computing system 102 and the endpoint 110 may belong to/be associated with the same organization. In some aspects, the computing system 102 may belong to/be associated with a first organization and the endpoint 110 may belong to/be associated with a second organization, where the first organization may provide cybersecurity related services to the second organization.

As the computing system 102 monitors the endpoint 110, the computing system 102 may detect events 112 that occur at the endpoint 110. In general, the events 112 may include receiving data at the endpoint 110, transmitting data at the endpoint 110, executing processes at the endpoint 110, etc. The events 112 may each be related to a known cybersecurity threat (i.e., the same cybersecurity threat). In some aspects, the events 112 may include anomalous network activities. Anomalous network activities may include unusual patterns in a data flow and/or unexpected external communications that device from a norm. For example, a sudden spike in data transferred to an unknown Internet Protocol (IP) address may be an anomalous network activity. In some aspects, the events 112 may include suspicious user behavior. Suspicious user behavior may include logins at unexpected hours, repeated attempts to access restricted systems/software, and/or an unusual surge in a data access request. In some aspects, the events 112 may include system level indicators. System level indicators may include unexpected changes in file integrity, unauthorized modifications to system configurations, and/or installation of unknown software. In an example, the events 112 may include a first event 114 detected at the endpoint 110 and a second event 116 detected at the endpoint 110; however, it is to be understood that the concepts herein are applicable to any number of events (e.g., three events, four events, five events, etc.).

The computing system 102 may group the events 112 into an incident report 118, that is, the computing system 102 may generate the incident report 118 based on a grouping technique. For instance, the computing system 102 may execute a clustering algorithm or utilize a heuristic to generate the incident report 118. The incident report 118 may include indications of the events 112. In some aspects, the incident report 118 may be fixed once generated, that is, events may not be added to the incident report 118 once the incident report is generated. In some aspects, the incident report 118 may dynamically grow as the computing system 102 detects additional events. In some aspects, the incident report 118 may be fixed once the computing system 102 initiates a scoring process (described in greater detail below).

The computing system 102 may be configured with a first cyberthreat detection technique 120. The first cyberthreat detection technique 120 may include/be associated with a first scoring process 122 and a first threshold score 124. In general, the first scoring process 122, when executed by the processing device 104, may assign scores to each of the events 112 based on a type of the event. In an example, the first event 114 is a first type of event and the second event 116 is a second type of event, and the computing system 102 may assign a first score 126 (e.g., “5”) to the first event 114 and a second score 128 (e.g., “6”) to the second event 116. In some aspects, a score (e.g., the first score 126, the second score 128, etc.) assigned to an event (e.g., the first event 114, the second event 116) may be indicative of an unusualness (i.e., a rarity) of the event at the endpoint 110. In some aspects, a score assigned to an event may not be indicative of a severity of the event (i.e., how impactful the event is from a cybersecurity perspective).

The computing system 102 may compute a summed score 130 while performing the first scoring process 122. After the computing system 102 assigns the first score 126 to the first event, the computing system 102 may add the first score 126 to a default score of zero. After the computing system 102 assigns the second score 128 to the second event 116, the computing system may add the second score 128 to the first score 126. The computing system 102 may continue adding to the summed score 130 in this manner until the summed score 130 exceeds the first threshold score 124. In some aspects, the computing system 102 may compute the summed score 130 as the incident report 118 is being generated. For instance, the computing system 102 may assign a score to an event as each event is added to the incident report 118. In some aspects, the first threshold score 124 may be selected based on a capability of an analyst to review events. For instance, if the first threshold score 124 is relatively large, the analyst (or an automated mechanism) may have to review a relatively large number of events when the summed score 130 exceeds the first threshold score 124, whereas if the first threshold score 124 is relatively small, the analyst (or an automated mechanism) may have to review a relatively small number of events when the summed score 130 exceeds the first threshold score 124.

The computing system 102 may also record time instances as the computing system 102 assigns scores to the events 112. For example, when the computing system 102 assigns the first score 126 to the first event 114, the computing system 102 may record a first time instance 132 at which the computing system 102 assigned the first score 126 to the first event 114, and when the computing system assigns the second score 128 to the second event 116, the computing system 102 may record a second time instance 134 at which the computing system 102 assigned the second score 128 to the second event 116. Alternatively, the first time instance 132 may correspond to a time at which the computing system 102 began to execute the first cyberthreat detection technique 120.

The computing system 102 may continue the first scoring process 122. If the summed score 130 does not exceed the first threshold score 124 after all of the events 112 in the incident report are scored, the computing system 102 may determine that a risk of an ongoing cyberthreat is unlikely. Upon determining that the summed score 130 exceeds the first threshold score 124, the computing system may record a first timestamp 139 corresponding to when the summed score 130 exceeded the first threshold score 124. The computing system 102 may surface an indication of a cyberthreat (e.g., surface the indication of the cyberthreat one time) while continuing to perform the first scoring process 122 on additional event(s) in the incident report 118. For instance, if the incident report 118 includes a third event (not depicted in FIG. 1) and the computing system 102 determines that the summed score 130 exceeds the first threshold score 124, the computing system 102 may score the third event in the incident report 118 while not surfacing further indications of the cyberattack.

Upon determining that the summed score 130 exceeds the first threshold score 124, the computing system 102 may compute a difference 136 (or an absolute value of the difference 136) between the first timestamp 139 (at which the summed score 130 exceeded the first threshold score 124) and a second timestamp 141 at which at a second cyberthreat detection technique 140 detected a cyberthreat with respect to the endpoint 110. The second cyberthreat detection technique 140 may be different from the first cyberthreat detection technique 120. The second cyberthreat detection technique 140 may include/be associated with a second scoring process 142 and a second threshold score 144. At least one of the second scoring process 142 or the second threshold score 144 may be different from the first scoring process 122 or the first threshold score 124, respectively.

In some aspects, the second cyberthreat detection technique 140 may be executed by the computing system 102. For instance, the computing system 102 may begin to concurrently execute the first cyberthreat detection technique 120 and the second cyberthreat detection technique 140 at the same time (or at different times). When the second cyberthreat detection technique 140 detects the cyberthreat, the computing system 102 may record the second timestamp 141 corresponding to when the second cyberthreat detection technique 140 detected the cyberthreat. The computing system 102 may compute the difference 136 between the first timestamp 139 and the second timestamp 141 as described above.

In some aspects, the second cyberthreat detection technique 140 may be executed by a second computing system (e.g., a cybersecurity team device 111). For instance, as the computing system 102 executes the first cyberthreat detection technique 120 with respect to the endpoint 110, the second computing system may execute the second cyberthreat detection technique 140. In an example, the second computing system may begin to execute the second cyberthreat detection technique 140 at the same as the computing system 102 begins to execute the first cyberthreat detection technique 120, or the second computing system may begin to execute the second cyberthreat detection technique 140 at a different time from a time at which the computing system 102 begins to execute the first cyberthreat detection technique 120. When the second cyberthreat detection technique 140 (executed by the second computing system) detects the cyberthreat, the second computing system may record the second timestamp 141. The second computing system may transmit an indication of the second timestamp 141 to the computing system 102, whereupon the computing system 102 may compute the difference 136 between the first timestamp 139 and the second timestamp 141 as described above.

The computing system 102 may output an indication of the difference 136 (e.g., responsive to computing the difference 136). In one example, the computing system 102 may present the indication of the difference 136 and an identifier for the first cyberthreat detection technique 120 and/or an identifier for the second cyberthreat detection technique 140 on a display of the computing system 102. In another example, the computing system 102 may transmit, over a network, the indication of the difference 136 and the identifier for the first cyberthreat detection technique 120 and/or the identifier for the second cyberthreat detection technique 140 to a cybersecurity team device 111, whereupon the cybersecurity team device 111 may present the indication of the difference 136 and the identifier for the first cyberthreat detection technique 120 and/or the identifier for the second cyberthreat detection technique 140 (e.g., on a display). In some aspects, the cybersecurity team device 111 may be or include the computer system 500 described in FIG. 5. In yet another example, the computing system 102 may transmit, over a network, the indication of the difference 136 and the identifier for the first cyberthreat detection technique 120 and/or the identifier for the second cyberthreat detection technique 140 to the endpoint 110, whereupon the endpoint 110 may present the indication of the difference 136 and the identifier for the first cyberthreat detection technique 120 and/or the identifier for the second cyberthreat detection technique 140 (e.g., on a display).

Upon determining that the summed score 130 exceeds the first threshold score 124, in some aspects, the computing system 102 may output an indication of a cyberattack 138 (e.g., an in-progress cyberattack) with respect to the endpoint 110, that is, the computing system 102 may indicate that the endpoint 110 is undergoing a cyberattack or that the endpoint 110 is likely undergoing a cyberattack. In one example, the computing system 102 may present the indication of the cyberattack 138 on a display of the computing system 102. In another example, the computing system 102 may transmit, over a network, the indication of the cyberattack 138 to a cybersecurity team device 111, whereupon the cybersecurity team device 111 may present the indication of the cyberattack 138 (e.g., on a display). In some aspects, an analyst operating the cybersecurity team device 111 may investigate the cyberattack. For instance, the cybersecurity team device 111 may obtain additional information about the endpoint 110. In yet another example, the computing system 102 may transmit, over a network, the indication of the cyberattack 138 to the endpoint 110, whereupon the endpoint 110 may present the indication of the cyberattack 138 (e.g., on a display). In some aspects, the computing system 102 may perform a remedial action with respect to the endpoint 110 to address the cyberattack 138. For example, the computing system 102 may reset token(s) associated with the endpoint 110, quarantine the endpoint 110, restrict privileges of the endpoint 110, etc.

Although the incident report 118 is described above as being for a (single) endpoint, other possibilities are contemplated. In some aspects, the incident report 118 may include events detected across multiple endpoints (e.g., multiple endpoints belonging to the same organization). As such, the computing system 102 may evaluate an efficacy of a cyberthreat detection technique across multiple endpoints using the concepts described herein.

In some aspects, the computing system 102 may generate additional evaluation metrics (e.g., ROC curves, precision recall, TPR curves, AUC, etc.) in addition to computing the difference 136. In such aspects, the computing system 102 may output the additional evaluation metrics in addition to outputting the difference 136.

Although the computing system 102 is described above as computing a difference between the first timestamp 139 and the second timestamp 141, other possibilities are contemplated. In some aspects, the computing system computes a first value for the first cyberthreat detection technique 120, where the first value is a difference between the second time instance 134 (i.e., a time instance at which the summed score 130 exceeded the first threshold score 124 and the first time instance 132 (i.e., a time at which the first scoring process 122 began). The computing system 102 (or another computing system) computes a second value, where the second value is a difference between a time instance at which the second cyberthreat detection technique 140 detected a cyberthreat and a time instance at which the second cyberthreat detection technique 140 began to execute. Alternatively, a second computing system may compute the second value and the second computing system may transmit the second value to the computing system 102. The computing system 102 may compute a difference between the first value and the second value.

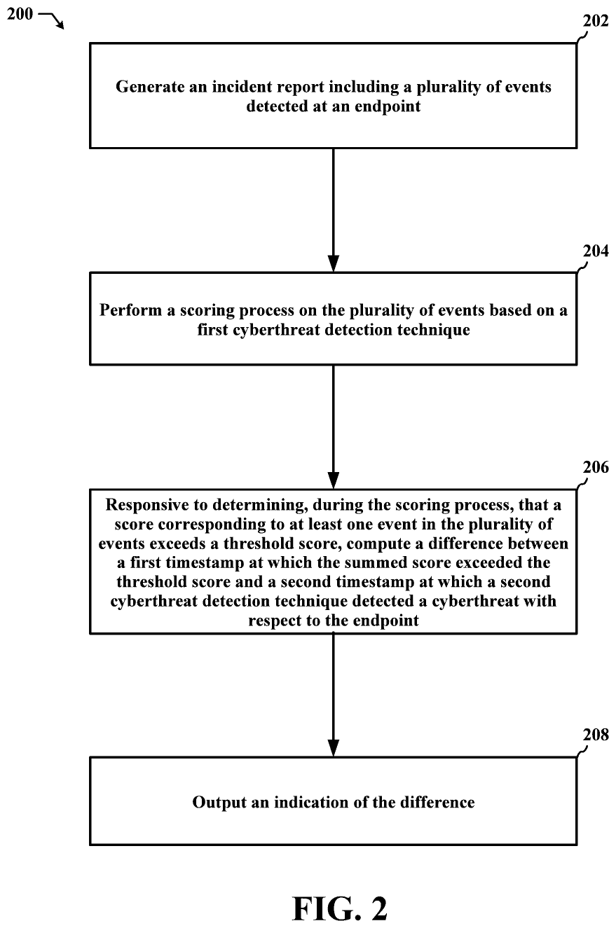

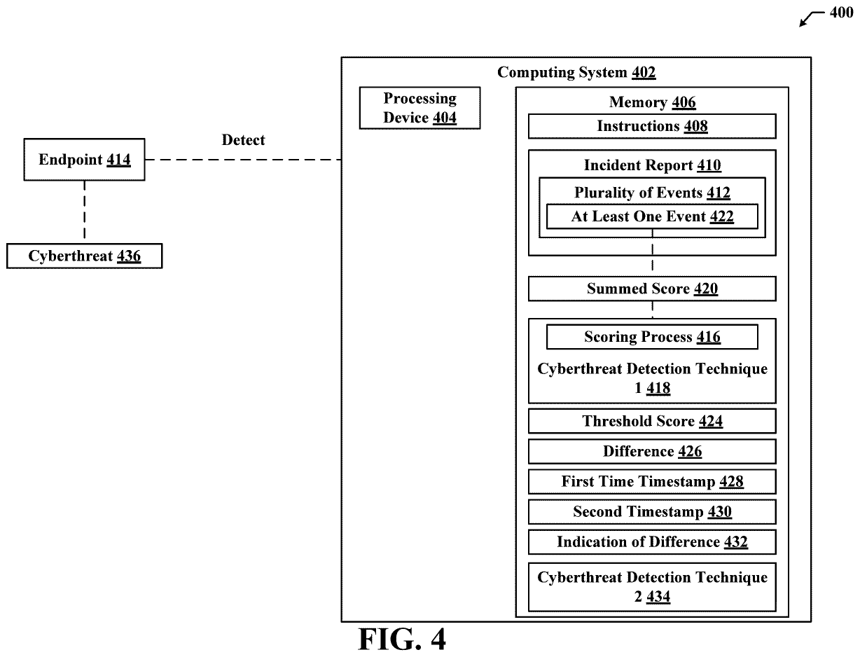

FIG. 2 is a flow diagram 200 of a method for computing an efficacy of a cyberthreat detection technique using proximity of detections in accordance with some aspects of the present disclosure. The method may be performed by processing logic that may include hardware (e.g., a processing device), software (e.g., instructions running/executing on a processing device), firmware (e.g., microcode), or a combination thereof. In some aspects, at least a portion of the method may be performed by the processing device 104 (shown in FIG. 1), the processing device 404 (shown in FIG. 4), the processing device 502 (shown in FIG. 5), or a combination thereof.

The method illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in the method may be performed in an order different than presented, and that not all of the blocks in the method may be performed.

At block 202, a processing device generates an incident report comprising a plurality of events detected at an endpoint. In an example, the incident report may be or include the incident report 118, the plurality of events may be or included the events 112, and the endpoint may be or include the endpoint 110. In another example, the incident report may be or include the incident report 410, the plurality of events may be or included the plurality of events 412, and the endpoint may be or include the endpoint 414.

At block 204, the processing device performs a scoring process on the plurality of events based on a first cyberthreat detection technique. In an example, the scoring process may be or include the first scoring process 122 and the first cyberthreat detection technique may be or include the first cyberthreat detection technique 120. In another example, the scoring process may be or include the scoring process 416 and the first cyberthreat detection technique may be or include the first cyberthreat detection technique 418.

At block 206, responsive to determining, during the scoring process, that a summed score corresponding to at least one event in the plurality of events exceeds a threshold score, the processing device computes a difference between a first timestamp at which the summed score exceeded the threshold score and a second timestamp at which a second cyberthreat detection technique detected a cyberthreat with respect to the endpoint. In an example, the summed score may be or include the summed score 130, the at least one event may be or include the first event 114 and the second event 116, the difference may be or include the difference 136, the first timestamp may be or include the first timestamp 139, the threshold score may be or include the first threshold score 124, the second timestamp may be or include the second timestamp 141, and the second cyberthreat detection technique may be or include the second cyberthreat detection technique 140. In another example, the summed score may be or include the summed score 420, the at least one event may be or include the at least one event 422, the difference may be or include the difference 426, the first timestamp may be or include the first timestamp 428, the threshold score may be or include the threshold score 424, the second timestamp may be or include the second timestamp 430, and the second cyberthreat detection technique may be or include the second cyberthreat detection technique 434.

At block 208, the processing device outputs an indication of the difference. For example, FIG. 1 shows that the computing system 102 may output the indication of the difference 136. For example, FIG. 4 shows that the computing system 102 may output an indication of the difference 432.

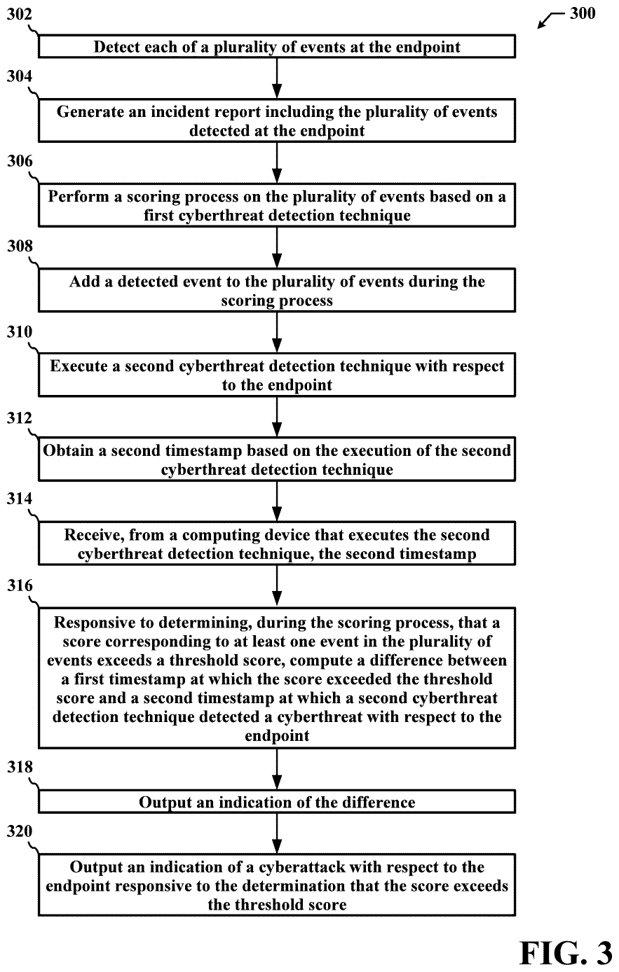

FIG. 3 is a flow diagram 300 of a method for computing an efficacy of a cyberthreat detection technique using proximity of detections in accordance with some aspects of the present disclosure. The method may be performed by processing logic that may include hardware (e.g., a processing device), software (e.g., instructions running/executing on a processing device), firmware (e.g., microcode), or a combination thereof. In some aspects, at least a portion of the method may be performed by the processing device 104 (shown in FIG. 1), the processing device 404 (shown in FIG. 4), the processing device 502 (shown in FIG. 5), or a combination thereof.

The method illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in the method may be performed in an order different than presented, and that not all of the blocks in the method may be performed.

In some aspects, at block 302, a processing device may detect each of a plurality of events at an endpoint. For example, the plurality of events may be or include the events 112 and the endpoint may be or include the endpoint 110. In another example, the plurality of events may be or include the plurality of events 412 and the endpoint may be or include the endpoint 414.

At block 304, the processing device generates an incident report comprising the plurality of events detected at the endpoint. For example, the incident report may be or include the incident report 118. In another example, the incident report may be or include the incident report 410.

In some aspects, generating the incident report may be based on the detection of the plurality of events at the endpoint. For example, the aforementioned aspect may correspond to the description of FIG. 1 described above.

In some aspects, the plurality of events at the endpoint may include a plurality of related events at the endpoint. For example, the aforementioned aspect may correspond to the description of FIG. 1 described above.

At block 306, the processing device performs a scoring process on the plurality of events based on a first cyberthreat detection technique. For example, the scoring process may be or include the first scoring process 122 and the first cyberthreat detection technique may be or include the first cyberthreat detection technique 120.

In some aspects, at block 308, the processing device may add a detected event to the plurality of events during the scoring process. For example, the computing system 102 may add a detected event to the events 112 during the first scoring process 122.

In some aspects, at block 310, the processing device may execute a second cyberthreat detection technique with respect to the endpoint. For example, the aforementioned aspects may correspond to the description of FIG. 1 above.

In some aspects, at block 312, the processing device may obtain a second timestamp based on the execution of the second cyberthreat detection technique. The second timestamp may correspond to a date and time at which the second cyberthreat detection technique detected a cyberthreat.

In some aspects, at block 314, the computing system may receive, from a computing device that executes the second cyberthreat detection technique, the second timestamp. In an example, the computing device may be or include the cybersecurity team device 111.

At block 316, responsive to determining, during the scoring process, that a summed score corresponding to at least one event in the plurality of events exceeds a threshold score, the processing device computes a difference between a first timestamp at which the summed score exceeded the threshold score and a second timestamp at which a second cyberthreat detection technique detected a cyberthreat with respect to the endpoint. In an example, the summed score may be or include the summed score 130, the at least one event may be or include the first event 114 and the second event 116, the difference may be or include the difference 136, the first timestamp may be or include the first timestamp 139, the threshold score may be or include the first threshold score 124, the second timestamp may be or include the second timestamp 141, and the second cyberthreat detection technique may be or include the second cyberthreat detection technique 140. In another example, the summed score may be or include the summed score 420, the at least one event may be or include the at least one event 422, the difference may be or include the difference 426, the first timestamp may be or include the first timestamp 428, the threshold score may be or include the threshold score 424, the second timestamp may be or include the second timestamp 430, and the second cyberthreat detection technique may be or include the second cyberthreat detection technique 434.

In some aspects, determining that the summed score exceeds the threshold score may be based on the added detected event. For example, the aforementioned aspect may correspond to the description of FIG. 1 described above.

At block 318, the processing device outputs an indication of the difference. For example, FIG. 1 shows that the computing system 102 may output the indication of the difference 136. For example, FIG. 4 shows that the computing system 102 may output an indication of the difference 432.

In some aspects, at block 320, the processing device may output an indication of a cyberattack with respect to the endpoint responsive to the determination that the summed score exceeds the threshold score. For example, the indication of the cyberattack may be or include the indication of the cyberattack 138.

In some aspects, the plurality of events may include a plurality of sequential events occurring at the endpoint, and performing the scoring process may include performing a sequential scoring process on the plurality of sequential events. For example, the aforementioned aspect may correspond to the description of FIG. 1 described above.

In some aspects, performing the scoring process may include assigning a first score to a first event in the plurality of events, assigning a second score to a second event in the plurality of events, and summing the first score and the second score to generate the summed score. For example, the first score may be or include the first score 126, the first event may be or include the first event 114, the second score may be or include the second score 128, and the second event may be or include the second event 116.

In some aspects, performing the scoring process may include assigning a score to each of the plurality of events, where the summed score may be indicative of an unusualness of the event at the endpoint. For example, the aforementioned aspect may correspond to the description of FIG. 1 described above.

In some aspects, outputting the indication of the difference may include transmitting the indication of the difference to a computing device. For example, the aforementioned aspect may correspond to the description of FIG. 1 described above. In an example, the computing device may be or include the cybersecurity team device 111.

In some aspects, the cyberthreat detection technique may be based on information pertaining to known cyberattacks. For example, the aforementioned aspect may correspond to the description of FIG. 1 described above.

FIG. 4 is a block diagram 400 that illustrates an example of a computing system 402 for computing an efficacy of a cyberthreat detection technique using proximity of detections in accordance with some aspects of the present disclosure. In some aspects, the computing system 402 may perform some or all of the functionality described herein. The computing system 402 includes a processing device 404 and memory 406. The memory 406 stores instructions 408 that are executed by the processing device 404. The instructions 408, when executed by the processing device 404, cause the processing device 404 to generate an incident report 410 including a plurality of events 412 detected at an endpoint 414. The instructions 408, when executed by the processing device 404, cause the processing device 404 to perform a scoring process 416 on the plurality of events 412 based on a first cyberthreat detection technique 418. The instructions 408, when executed by the processing device 404, cause the processing device 404 to determine, during the scoring process 416, that a summed score 420 corresponding to at least one event 422 in the plurality of events 412 exceeds a threshold score 424. Responsive to the determination, the instructions 408, when executed by the processing device 404, cause the processing device 404 to compute a difference 426 between a first timestamp 428 at which the summed score 420 exceeded the threshold score 424 and a second timestamp 430 at which a second cyberthreat detection technique 434 detected a cyberthreat 436 associated with at least one event 422 in the plurality of events 412. The instructions 408, when executed by the processing device 404, cause the processing device 404 to output an indication of the difference 432.

Mechanisms for evaluating cyberthreat detection techniques (e.g., cyberthreat detection models, algorithms, etc.) for compromised endpoints exist. For example, evaluation mechanisms for evaluating cyberthreat detection techniques may include receiver operating characteristic (ROC) curves, precision/recall, and true positive rate (TPR) curves. The evaluation mechanisms may also include reduced metrics, such as area under the curve (AUC). The aforementioned evaluation mechanisms may suffer from various drawbacks which may be specific to cybersecurity. For instance, the aforementioned evaluation mechanisms may ignore latency in detection as a metric. Stated differently, the aforementioned evaluation mechanisms may indicate an effectiveness of existing cyberthreat detection techniques while ignoring earliness.

Aspects presented herein pertain to computing an efficacy of an algorithm (e.g., a cyberthreat detection algorithm) using proximity of detections on a device. The aspects presented herein include an efficacy framework that addresses shortcomings of ROC curves. The efficacy framework uses an incident paradigm to identify a compromised endpoint and then uses a time anchored score from a cyberthreat detection technique (e.g., a cyberthreat detection algorithm) to address latency (i.e., earliness/lateness) of notifications relative to a reference time. The application of an incident paradigm and earliness to a compromised endpoint may provide improvements to the field of cybersecurity.

FIG. 5 illustrates a diagrammatic representation of a machine in the example form of a computer system 500 within which a set of instructions, for causing the machine to perform any one or more of the methodologies discussed herein for computing an efficacy of a cyberthreat detection technique using proximity of detections.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, the computer system 500 may be representative of a server.

The computer system 500 includes a processing device 502, a main memory 504 (e.g., read-only memory (ROM), flash memory, dynamic random access memory (DRAM), a static memory 505 (e.g., flash memory, static random access memory (SRAM), etc.), and a data storage device 518 which communicate with each other via a bus 530. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

The computer system 500 may further include a network interface device 508 which may communicate with a network 520. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 515 (e.g., an acoustic signal generation device, such as a speaker). In some embodiments, the video display unit 510, the alphanumeric input device 512, and the cursor control device 514 may be combined into a single component or device (e.g., an LCD touch screen).

The processing device 502 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. The processing device 502 may also be one or more special-purpose processing devices such as an application specific integrated circuit (ASIC), a field programmable gate array (FPGA), a digital signal processor (DSP), network processor, or the like. The processing device 502 is configured to execute cyberattack detection efficacy instructions 525, for performing the operations and steps discussed herein. For example, the cyberattack detection efficacy instructions 525 may include instructions for generating an incident report including a plurality of events detected at an endpoint. The cyberattack detection efficacy instructions 525 may include instructions for performing a scoring process on the plurality of events based on a first cyberthreat detection technique. The cyberattack detection efficacy instructions 525 may include instructions for responsive to determining, during the scoring process, that a summed score corresponding to at least one event in the plurality of events exceeds a threshold score, computing a difference between a first timestamp at which the summed score exceeded the threshold score and a second timestamp at which a second cyberthreat detection technique detected a cyberthreat with respect to the endpoint. The cyberattack detection efficacy instructions 525 may include instructions for outputting an indication of the difference.

The data storage device 518 may include a machine-readable storage medium 528 that stores the cyberattack detection efficacy instructions 525 (e.g., software) embodying any one or more of the methodologies of functions described herein. The cyberattack detection efficacy instructions 525 may also reside, completely or at least partially, within the main memory 504 or within the processing device 502 during execution thereof by the computer system 500; the main memory 504 and the processing device 502 also constituting machine-readable storage media. The cyberattack detection efficacy instructions 525 may further be transmitted or received over a network 520 via the network interface device 508.

While the machine-readable storage medium 528 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable storage medium includes any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “generating,” “performing,” “determining,” “computing,” “calculating,” “inputting,” “outputting,” “transmitting,” “receiving,” “ceasing,” “causing,” “assigning,” “summing,” “comparing,” “adding,” “detecting,” “selecting,” “identifying,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission, or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112(f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method, comprising:
generating an incident report comprising a plurality of events detected at an endpoint;
performing a scoring process on the plurality of events based on a first cyberthreat detection technique;
responsive to determining, during the scoring process, that a summed score corresponding to at least one event in the plurality of events exceeds a threshold score, computing, by a processing device, a difference between a first timestamp at which the summed score exceeded the threshold score and a second timestamp at which a second cyberthreat detection technique detected a cyberthreat with respect to the endpoint; and
outputting an indication of the difference.

2. The method of claim 1, wherein the plurality of events comprises a plurality of sequential events occurring at the endpoint, and wherein the performing the scoring process comprises performing a sequential scoring process on the plurality of sequential events.

3. The method of claim 1, further comprising:
executing the second cyberthreat detection technique with respect to the endpoint; and
obtaining the second timestamp based on the execution of the second cyberthreat detection technique.

4. The method of claim 1, wherein the performing the scoring process comprises:
assigning a first score to a first event in the plurality of events;
assigning a second score to a second event in the plurality of events; and
summing the first score and the second score to generate the summed score.

5. The method of claim 1, further comprising:
outputting an indication of a cyberattack with respect to the endpoint responsive to the determination that the summed score exceeds the threshold score.

6. The method of claim 1, further comprising:
receiving, from a computing device that executes the second cyberthreat detection technique, the second timestamp.

7. The method of claim 1, wherein the performing the scoring process comprises assigning a score to each of the plurality of events, and wherein the score is indicative of an unusualness of the event at the endpoint.

8. The method of claim 1, wherein the outputting the indication of the difference comprises transmitting the indication of the difference to a computing device.

9. The method of claim 1, further comprising:
adding a detected event to the plurality of events during the scoring process, wherein the determining that the score exceeds the threshold score is based on the added detected event.

10. The method of claim 1, further comprising:
detecting each of the plurality of events at the endpoint, wherein the generating the incident report is based on the detection.

11. The method of claim 1, wherein the plurality of events detected at the endpoint comprises a plurality of related events at the endpoint.

12. The method of claim 1, wherein the first cyberthreat detection technique is based on information pertaining to known cyberattacks.

13. A system, comprising:
a processing device; and
a memory to store instructions that, when executed by the processing device, cause the processing device to:
generate an incident report comprising a plurality of events detected at an endpoint;
perform a scoring process on the plurality of events based on a first cyberthreat detection technique;
determine, during the scoring process, that a summed score corresponding to at least one event in the plurality of events exceeds a threshold score;
responsive to the determination, compute a difference between a first timestamp at which the summed score exceeded the threshold score and a second timestamp at which a second cyberthreat detection technique detected a cyberthreat with respect to the endpoint; and
output an indication of the difference.

14. The system of claim 13, wherein to perform the scoring process, the instructions, when executed by the processing device, cause the processing device to:
assign a first score to a first event in the plurality of events;
assign a second score to a second event in the plurality of events; and
sum the first score and the second score to generate the summed score.

15. The system of claim 13, wherein the instructions, when executed by the processing device, cause the processing device further to:
receive, from a computing device that executes the second cyberthreat detection technique, the second timestamp.

16. A non-transitory computer readable medium, having instructions stored thereon which, when executed by a processing device, cause the processing device to:
generate an incident report comprising a plurality of events detected at an endpoint;
perform a scoring process on the plurality of events based on a first cyberthreat detection technique;
determine, during the scoring process, that a summed score corresponding to at least one event in the plurality of events exceeds a threshold score;
responsive to the determination, compute, by the processing device, a difference between a first timestamp at which the summed score exceeded the threshold score and a second timestamp at which a second cyberthreat detection technique detected a cyberthreat with respect to the endpoint; and
output an indication of the difference.

17. The non-transitory computer readable medium of claim 16, wherein to perform the scoring process, the instructions, when executed by the processing device, cause the processing device to:
assign a first score to a first event in the plurality of events;
assign a second score to a second event in the plurality of events; and
sum the first score and the second score to generate the summed score.

18. The non-transitory computer readable medium of claim 16, wherein the instructions, when executed by the processing device, cause the processing device further to:
receive, from a computing device that executes the second cyberthreat detection technique, the second timestamp.

19. The non-transitory computer readable medium of claim 16, wherein the instructions, when executed by the processing device, cause the processing device further to:
execute the second cyberthreat detection technique; and
obtain the second timestamp based on the execution of the second cyberthreat detection technique.

20. The non-transitory computer readable medium of claim 16, wherein to perform the scoring process, the instructions, when executed by the processing device, cause the processing device to assign a score to each of the plurality of events, and wherein the score is indicative of an unusualness of the event at the endpoint.
